(19) United States
(12) Patent Application Publication
(10) Pub. No.: US 2018/0162114 A1
(43) Pub. Date: Jun. 14, 2018

(54) PRESSURIZED REDUCTION OF CNT RESISTIVITY

(71) Applicant: Goodrich Corporation, Charlotte, NC (US)

(72) Inventors: Jin Hu, Hudson, OH (US); Galdemir Cezar Botura, Akron, OH (US); Casey Slane, Richwood, OH (US); Nathaniel Ching, Uniontown, OH (US)

(21) Appl. No.: 15/373,370

(22) Filed: Dec. 8, 2016

(51) Int. Cl. B32B 37/16; B32B 5/26; B32B 15/14; B32B 5/02; B32B 15/20; B32B 27/12; B32B 27/32; B32B 37/10; D06C 15/00

(52) U.S. Cl. CPC B32B 37/16; B32B 2313/04; B32B 15/14; B32B 5/022; B32B 15/20; B32B 27/12; B32B 27/322; B32B 37/10; D06C 15/00; B32B 2262/106; B32B 2262/101; B32B 2605/18; B32B 2307/202; B32B 2327/18; B32B 2311/24; B32B 5/26

(57) ABSTRACT

A method for reducing the resistivity of a carbon nanotube nonwoven sheet includes providing a carbon nanotube nonwoven sheet comprising a plurality of carbon nanotubes and applying pressure to the carbon nanotube nonwoven sheet to reduce air voids between carbon nanotubes within the carbon nanotube nonwoven sheet.

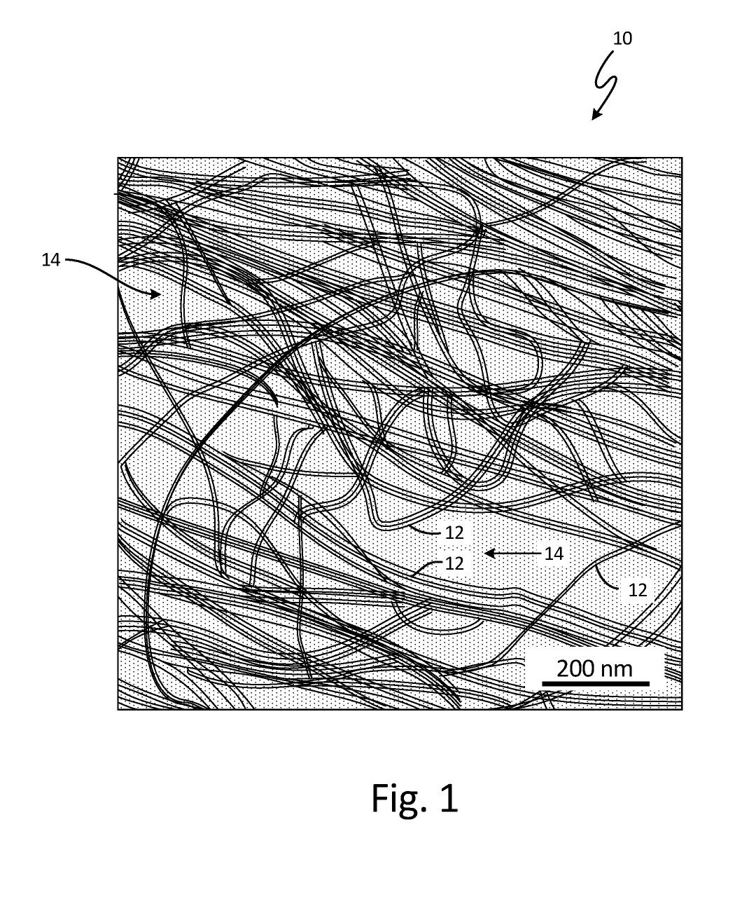

### BACKGROUND

Carbon nanotubes (CNTs) are carbon allotropes having a generally cylindrical nanostructure. They have unusual properties that make them valuable for many different technologies. For instance, some CNTs can have high thermal and electrical conductivity, making them suitable for replacing metal heating elements. Due to their much lighter mass, substituting CNTs for metal heating components can reduce the overall weight of a heating component significantly. This makes the use of CNTs of particular interest for applications where weight is critical, such as in aerospace and aviation technologies.

Carbon nanotubes are commercially available in several different forms. One such form is as a pure carbon nanotube nonwoven sheet material (CNT-NSM). In a CNT-NSM, carbon nanotubes are arranged together to form a sheet. No adhesives or polymers are used to attach CNTs to one another in a CNT-NSM. Instead, CNT particles are attached to one another via Van der Waals forces. However, the electrical conductivity of these commercially available, off-the-shelf CNT-NSMs is generally in the range of 350-400 S/cm or lower. This level of electrical conductivity is not suitable for many aerospace heating applications (e.g., anti-icing and de-icing). Thus, commercially available CNT-NSMs cannot currently be used as a substitute for metal heating elements.

### SUMMARY

A method for reducing the resistivity of a carbon nanotube nonwoven sheet includes providing a carbon nanotube nonwoven sheet comprising a plurality of carbon nanotubes and applying pressure to the carbon nanotube nonwoven sheet to reduce air voids between carbon nanotubes within the carbon nanotube nonwoven sheet.

### BRIEF DESCRIPTION OF THE DRAWINGS

The FIGURE is a schematic view of a magnified portion of a carbon nanotube nonwoven sheet material (CNT-NSM).

### DETAILED DESCRIPTION

This disclosure provides methods for reducing the resistivity of a carbon nanotube (CNT) nonwoven sheet material (CNT-NSM). The resistivity of a CNT-NSM is reduced by removing air voids between CNTs within the CNT-NSM. Air voids are removed from the CNT-NSM by the application of pressure to the CNT-NSM. The disclosed methods allow for the improvement of CNT heating elements without the addition of mass or the addition of functional groups using chemical processes.

The FIGURE schematically illustrates one example of a portion of a carbon nanotube nonwoven sheet. CNT nonwoven sheet 10 includes a plurality of carbon nanotubes (CNTs) 12 that are attached together to form sheet 10. CNT nonwoven sheet 10 is generally manufactured as a flat sheet or tape that is very thin, as thin as or thinner than the thickness of an ordinary sheet of paper (about 0.07 to 0.18 millimeters). The length and width of sheet 10 can vary depending on manufacturer or customer selection. The FIGURE schematically illustrates a magnified view of sheet 10 to illustrate individual CNTs 12.

In some embodiments, CNT nonwoven sheet 10 includes only carbon nanotubes 12 and sheet 10 is free of the adhesives, resins and polymers that are often used as a matrix that incorporate CNT particles. In these cases of pure CNT-NSMs, CNTs 12 are held together by Van der Waals forces or interactions. Van der Waals forces are non-covalent and non-ionic attractive forces between CNTs caused by fluctuating polarizations of the CNTs. Individual carbon nanotubes 12 can align themselves by pi-stacking, one type of Van der Waal interaction. Pi-stacking refers to attractive, non-covalent interactions between aromatic rings that occur due to the presence of pi bonds. As each carbon ring within a CNT possesses pi bonds, pi-stacking occurs between nearby CNTs 12. As pure CNT-NSMs (such as sheet 10) do not contain adhesives, resins and polymers, they are sometimes referred to as “dry” sheets.

As shown in the FIGURE, air voids 14 are present between some adjacent CNTs 12. Air voids 14 present in sheet 10 increase the resistivity (and reduce the conductivity, which is inversely proportional to the resistivity) of sheet 10. Air voids 14 are present in commercially available CNT-NSMs to such an extent that they increase the resistivity of sheet 10 and render them unsuitable for many anti-icing and de-icing applications on aircraft. For example, the lowest claimed resistivity of one commercially available, off-the-shelf CNT-NSM is about 0.4 ohms per square (Ω/sq). For some aircraft components, such as rotor blades, the resistivity of a heating element should be 0.1 Ω/sq or lower to provide sufficient anti-icing and/or de-icing. As disclosed herein, pressure is applied to commercially available CNT-NSMs to remove air voids 14 present in sheet 10 to decrease the resistivity of sheet 10. The application of pressure makes sheet 10 suitable for additional heating applications for which untreated CNT-NSMs are not.

Pressure can be applied to CNT nonwoven sheet 10 using different methods. In one embodiment, pressure is applied to sheet 10 using a machine press. The machine press can include two opposing plates that are pressed together with sheet 10 positioned between the two plates. As pressure is applied to sheet 10 by the plates, the size and/or number of air voids 14 present within sheet 10 are reduced. Reducing the size and number of air voids 14 in sheet 10 allows CNTs 12 within sheet 10 to be positioned closer together, thereby reducing the resistivity of sheet 10. The amount of pressure applied to sheet 10 by the plates can vary depending on the amount of air voids 14 present in sheet 10 and the amount of air voids 14 desired in sheet 10 after pressing. In some embodiments, the applied pressure can be about 689 kPa (100 psi). In theory, the applied pressure can be as high as possible as long as air voids 14 are being reduced in size and/or number and significant damage to sheet 10 is avoided.

To prevent the plates of the machine press from “sticking” to sheet 10 and possibly damaging sheet 10, a layer of foil or other material can be positioned on one or both sides of sheet 10 prior to pressing. For example, sheet 10 can be sandwiched between two layers of aluminum foil. In some cases, the side of the aluminum foil that contacts sheet 10 can be coated with polytetrafluoroethylene or another low surface energy material to prevent sheet 10 from sticking to the aluminum foil during or after pressing. Additionally, one or both of the plates can include a surface pattern that has one or more protrusions or recesses to provide greater or lesser pressure application at various locations of sheet 10. The surface pattern(s) allow for localized areas of varying resistivity on sheet 10. Sheet 10 then can be used in applications where varying resistivity of a heating element is desirable.

Heat energy can also be applied to sheet 10 before, during or after the application of pressure to sheet 10. The application of heat may further aid in the reduction of the size and/or number of air voids 14 present within sheet 10. One or both of the opposing plates of the machine press can be heated such that when the plates are pressed together, both pressure and heat energy is delivered to sheet 10. This pressure and heat energy are applied to sheet 10 essentially simultaneously. In some embodiments, the plates can be heated to a temperature of about 100° C. (212° F.). In theory, sheet 10 can be heated to a temperature as high as possible as long as air voids 14 are being reduced in size and/or number and significant damage to sheet 10 is avoided. In the case of heating sheet 10 before or after pressing, sheet 10 can be heated to a temperature within the above range.

In another embodiment, pressure is applied to sheet 10 using a set of nip rollers. Nip rollers are cylindrical rollers through which sheet 10 is fed. The outer diameter surfaces of two nip rollers are separated by a distance that is less than the thickness of sheet 10. The distances between the outer diameter surfaces of the nip rollers can vary along the interfacing length of the nip rollers. As sheet 10 passes between the two nip rollers, pressure is applied by the nip rollers to sheet 10. The pressures disclosed above with respect to the machine press can also be applied by a set of nip rollers. A set of nip rollers includes two or more rollers through which sheet 10 passes. The set of nip rollers can be heated in a fashion similar to the plates of a machine press to add heat energy at the time pressure is applied to sheet 10.

In another embodiment, an autoclave is used to apply pressure to sheet 10. Sheet 10 is positioned within the pressure chamber of an autoclave and sheet 10 is subjected to elevated pressure and temperature within the autoclave. The pressures and temperatures disclosed above with respect to the machine press can also be applied by an autoclave.

The methods of pressure application disclosed above describe the application of pressure to a pure CNT-NSM, such as CNT nonwoven sheet 10. The same methods can also be applied to a CNT nonwoven sheet that includes a backing material. The CNT nonwoven sheet can be layered on top of or beneath a backing material layer or sheet. The combined CNT nonwoven sheet and backing material can then be pressed using a machine press or set of nip rollers or positioned in an autoclave for pressure application. Alternatively, the backing material can be attached to a CNT nonwoven sheet by an adhesive or resin and then pressed or autoclaved. Suitable backing materials include glass fibers and pre-pregs (e.g., composite fibers in an epoxy matrix).

While the instant disclosure refers particularly to carbon nanotubes, it is theorized that the resistivity of sheets containing other electrically conductive carbon allotropes (e.g., graphene nanoribbons) would behave in a similar fashion. Embodiments containing other suitable carbon allotropes are within the scope of the instant disclosure.

The methods disclosed herein provide means for reducing the resistivity of CNT-NSMs without increasing their mass or the chemical processes needed to add resistivity-reducing functional groups to the carbon backbone of the CNT materials. The disclosure allows commercially available CNT-NSMs to be useful for aerospace and aircraft anti-icing and de-icing applications.

### Discussion of Possible Embodiments

The following are non-exclusive descriptions of possible embodiments of the present invention.

A method for reducing the resistivity of a carbon nanotube nonwoven sheet can include providing a carbon nanotube nonwoven sheet comprising a plurality of carbon nanotubes and applying pressure to the carbon nanotube nonwoven sheet to reduce air voids between carbon nanotubes within the carbon nanotube nonwoven sheet.

The method of the preceding paragraph can optionally include, additionally and/or alternatively, any one or more of the following features, configurations and/or additional components:

The method can further include heating the carbon nanotube nonwoven sheet.

The steps of applying pressure to the carbon nanotube nonwoven sheet and heating the carbon nanotube nonwoven sheet occur simultaneously.

The step of applying pressure to the carbon nanotube nonwoven sheet can be performed using a machine press.

The method can further include layering a foil on a side of the carbon nanotube nonwoven sheet prior to applying pressure to the carbon nanotube nonwoven sheet.

The foil can include aluminum and polytetrafluoroethylene.

The step of applying pressure to the carbon nanotube nonwoven sheet can be performed using a set of nip rollers.

The step of applying pressure to the carbon nanotube nonwoven sheet can be performed using an autoclave.

The carbon nanotube nonwoven sheet can include a plurality of carbon nanotubes held together by Van der Waals forces, and applying pressure to the carbon nanotube nonwoven sheet can reduce spacing between at least some adjacent carbon nanotubes.

The carbon nanotube nonwoven sheet can contain no adhesives or resins.

The carbon nanotube nonwoven sheet can be attached to a backing material.

The backing material can include glass fibers.

The backing material can include a pre-preg layer.

The carbon nanotube nonwoven sheet can consist essentially of carbon nanotubes.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A method for reducing the resistivity of a carbon nanotube nonwoven sheet, the method comprising:
providing a carbon nanotube nonwoven sheet comprising a plurality of carbon nanotubes; and
applying pressure to the carbon nanotube nonwoven sheet to reduce air voids between carbon nanotubes within the carbon nanotube nonwoven sheet.

2. The method of claim 1, further comprising:
heating the carbon nanotube nonwoven sheet.

3. The method of claim 2, wherein the steps of applying pressure to the carbon nanotube nonwoven sheet and heating the carbon nanotube nonwoven sheet occur simultaneously.

4. The method of claim 1, wherein the step of applying pressure to the carbon nanotube nonwoven sheet is performed using a machine press.

5. The method of claim 4, further comprising:
layering a foil on a side of the carbon nanotube nonwoven sheet prior to applying pressure to the carbon nanotube nonwoven sheet.

6. The method of claim 5, wherein the foil comprises aluminum and polytetrafluoroethylene.

7. The method of claim 1, wherein the step of applying pressure to the carbon nanotube nonwoven sheet is performed using a set of nip rollers.

8. The method of claim 1, wherein the step of applying pressure to the carbon nanotube nonwoven sheet is performed using an autoclave.

9. The method of claim 1, wherein the carbon nanotube nonwoven sheet comprises a plurality of carbon nanotubes held together by Van der Waals forces, and wherein applying pressure to the carbon nanotube nonwoven sheet reduces spacing between at least some adjacent carbon nanotubes.

10. The method of claim 1, wherein the carbon nanotube nonwoven sheet contains no adhesives or resins.

11. The method of claim 1, wherein the carbon nanotube nonwoven sheet is attached to a backing material.

12. The method of claim 11, wherein the backing material comprises glass fibers.

13. The method of claim 11, wherein the backing material comprises a pre-preg layer.

14. The method of claim 1, wherein the carbon nanotube nonwoven sheet consists essentially of carbon nanotubes.
